(19) United States
(12) Patent Application Publication
(10) Pub. No.: US 2023/0259617 A1
(43) Pub. Date: Aug. 17, 2023

(54) TOPOLOGY-BASED EVENT SUPPRESSION

(71) Applicant: VMware, Inc., Palo Alto, CA (US)

(72) Inventor: Patrick Joseph Romero, Portland, OR (US)

(21) Appl. No.: 17/673,695

(22) Filed: Feb. 16, 2022

(51) Int. Cl. G06F 21/55

(52) U.S. Cl. CPC G06F 21/554; G06F 2221/033

(57) ABSTRACT

In one set of embodiments, a computer system can receive an event pertaining to an activity performed by or associated with a software process. The computer system can compute an event hash value representing a type of the activity, a type of the software process, and a topology of the software process, where the topology indicates one or more parent software processes of the software process. The computer system can then perform a lookup into an event cache using the event hash value. If the event hash value is not found in the event cache, the computer system can cause the event to be transmitted to an event-receiving entity; otherwise, the computer system can drop/ignore/discard the event, thereby preventing it from being transmitted to the event-receiving entity.

### BACKGROUND

Unless otherwise indicated, the subject matter described in this section is not prior art to the claims of the present application and is not admitted as being prior art by inclusion in this section.

An endpoint protection system (EPS) is a security solution that protects an organization's computing endpoints (e.g., personal computers, smartphones, etc.) from various types of cyber threats. A typical EPS is composed of a client-side component that resides on each endpoint and a server-side component that resides on one or more centrally managed servers. The client-side component collects data regarding software processes running on the operating system (OS) of the endpoint, packages the collected data into objects referred to as events, and transmits the events to the server-side component. The server-side component then analyzes the received events (using, e.g., machine learning and/or other techniques) to detect and respond to threats that are revealed by the analysis, such as a malware attack, a network intrusion, and the like.

With existing EPS implementations, most if not all of the process data collected by each client-side component is sent to the server-side component, resulting in a large volume of events that need to be stored and analyzed on the server side. However, many of these events pertain to innocuous software processes and/or contain redundant information. Accordingly, existing EPS implementations expend significant resources on the transmission and processing of events that are ultimately irrelevant for threat detection.

### BRIEF DESCRIPTION OF THE DRAWINGS

FIG. 1 depicts an example environment comprising a client and a server system according to certain embodiments.

FIG. 2 depicts an enhanced version of the client of FIG. 1 that implements topology-based event suppression according to certain embodiments.

FIG. 3 depicts an event suppression flowchart according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for implementing topology-based event suppression, or in other words suppressing the transmission of events to an event-receiving entity (e.g., the server-side component of an EPS) based on the events' topological similarity to previously transmitted events. As used herein, an event is a data object that includes information regarding an activity performed by or associated with a software process (e.g., a file write operation, a network send/receive operation, etc.). Further, an event E1 for a software process P1 is deemed to be topologically identical to an event E2 for a software process P2 if (1) E1 and E2 pertain the same type of activity, (2) P1 and P2 are instances of the same type of software process, and (3) the topology of P1 (or in other words, the hierarchy/lineage of parent processes leading to P1) is identical to the topology of P2.

In one set of embodiments, the techniques of the present disclosure can include encoding the activity type, process type, and process topology for each of a plurality of events into an event hash value. This encoding process can comprise computing a topology hash value for the process associated with the event based on certain topology-invariant process characteristics (e.g., command line, binary path, associated user ID, etc.) and computing the event hash value based on the process's topology hash value. If the process was created/forked from a parent process, the process's topology hash value can be further based on a previously computed topology hash value for that parent process, thereby capturing the process's topology.

The event hash value can then be used to perform a lookup into an event cache. If the event hash value is not found in the event cache, the event can be transmitted to the event-receiving entity. However, if the event hash value is found the event cache (which means that a topologically identical event was recently transmitted), the event can be ignored/dropped. In this way, the techniques of the present disclosure can ensure that only topologically unique events (which will typically be the events of interest for threat detection and other similar tasks) are sent to the event-receiving entity for processing, thereby making efficient use of the entity's compute, storage, and network resources.

### 2. Example Environment and Solution Architecture

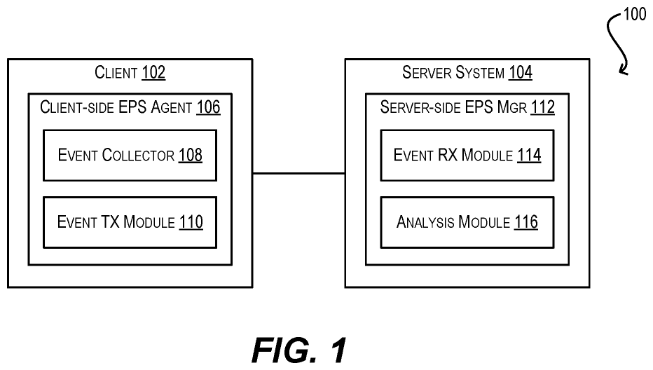

FIG. 1 depicts an example environment 100 comprising a client 102 and a server system 104 in which embodiments of the present disclosure may be implemented. As shown, client 102 (which may be a personal computer, smartphone, tablet, or any other type of computing endpoint) includes a client-side agent 106 of an endpoint protection system (EPS) that comprises an event collector 108 and an event transmit (TX) module 110. In addition, server system 104 (which may be a single machine or a cluster of machines that are located at the same premises as client 102 or in the cloud) includes a server-side manager 112 of the EPS that comprises an event receive (RX) module 114 and an analysis module 116.

In operation, event collector 108 of client-side EPS agent 106 monitors for certain activities performed by or associated with software processes running on client 102 and, upon detecting such activities, creates events encapsulating information regarding the activities and passes the events to event TX module 110. Event TX module 110 packages the events into payloads and transmits the event payloads to server-side EPS manager 112.

In response, event RX module 114 of server-side EPS manager 112 receives the event payloads, extracts the events contained therein, and provides the extracted events to analysis module 116. Analysis module 116 then applies one or more techniques for analyzing the events to identify and act upon security threats at client 102 revealed by that analysis (e.g., malware, ransomware, etc.).

As mentioned previously, in existing EPS implementations, most if not all of the events generated by event collector 108 of client-side EPS agent 106 are sent to server-side EPS manager 112 for analysis. While this ensures that important events indicative of security threats are not missed, it is also inefficient because the vast majority of events will pertain to non-malicious processes and/or contain redundant information (e.g., activities performed on a repeated basis). For example, under normal operating conditions (and assuming client 102 is hardened using standard preventative security measures), an actual attack on client 102 should be a relatively rare occurrence. Thus, existing EPS implementations waste a significant percentage of the compute and storage resources of server system 104, as well as the network bandwidth between client 102 and server system 104, on transmitting and processing events that are irrelevant for threat detection purposes.

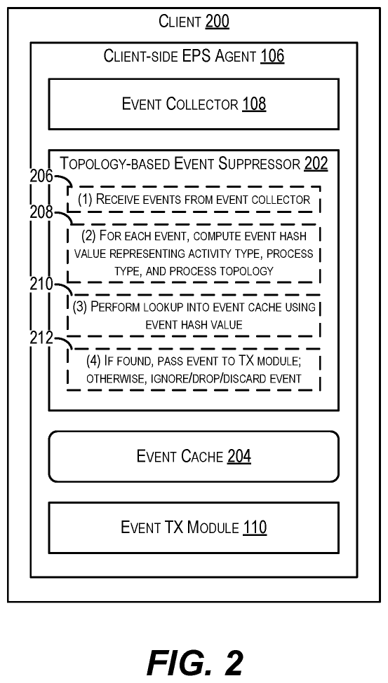

To address this and other similar issues, FIG. 2 depicts an enhanced version of client 102 of FIG. 1 (i.e., client 200) that includes a novel topology-based event suppressor 202 and event cache 204 within client-side EPS agent 106. In various embodiments, topology-based event suppressor 202 and event cache 204 may be implemented in software, in hardware, or via a combination thereof.

As shown in FIG. 2 and expanded upon in section (3) below, topology-based event suppressor 202 can carry out a high-level workflow that comprises receiving events from event collector 108 (step (1); reference numeral 206) and, for each event, computing an event hash value that represents the activity type of the event, the type of process associated with the event, and the topology of that process (if applicable) (step (2); reference numeral 208). For example, if the event pertains to a write to a file F by a software process P1 and P1 is a child of (i.e., was created/forked by) a parent process P2, the event hash value can represent the write to F, the type of P1, and P1's status as a child of a process of the same type as P2.

In one set of embodiments, the event hash value can be computed using a hash value for P1 (referred to as P1's “topology hash value”) that is in turn computed using certain topologically invariant/non-unique properties of P1 (e.g., command line, binary path, associated user ID, etc.) and a previously computed topology hash value for P2. By making P1's topology hash value dependent upon its parent's topology hash value, P1's topology hash value (and thus, the resulting event hash value) can capture the entire process hierarchy/lineage leading to P1 via a single, easily comparable number.

At step (3) (reference numeral 210), topology-based event suppressor 202 can perform a lookup into event cache 204 (which is keyed by event hash values) using the event hash value computed at step (2). Finally, if the event hash value is found in event cache 204, topology-based event suppressor 202 can pass the event to event TX module 110 for transmission to server-side EPS manager 112 and add the event hash value to the cache; otherwise, topology-based event suppressor 202 can simply ignore/drop/discard the event, such that it is not sent to server-side EPS manager 112 (step (4); reference numeral 212).

With the high-level workflow shown in FIG. 2, a number of advantages are realized. First, topology-based event suppressor 202 limits the events that are propagated to server-side EPS manager 112 to those that are topologically unique from the events previously transmitted and cached in event cache 204. Such topologically unique events are likely to be interesting to analysis module 116 for threat detection because they correspond to activities that have not been seen on client 102 before (and thus are potentially indicative of malicious behavior). In contrast, events that are topologically identical to previously transmitted events are not likely to be interesting because they correspond to known/previously analyzed activities. Accordingly, topology-based event suppressor 202 reduces the total amount of event data sent to server-side EPS manager 112 for processing and thus improves the overall efficiency of the system, without adversely affecting threat detection accuracy.

Second, by encoding all of the relevant properties of each event into a single number (i.e., the event hash value), topology-based event suppressor 202 can quickly and easily check the topological similarity of two events. In addition, by encoding the topology of each process via a topology hash value that is based on the topology hash value of its immediate parent, topology-based event suppressor 202 can quickly compute topology hash values for new child processes by simply retrieving the previously computed topology hash values of their parents. Such previously computed topology hash values can be maintained by topology-based event suppressor 202 in a data cache (keyed by, e.g., process identifier (ID)) that is separate from event cache 204.

It should be appreciated that FIGS. 1 and 2 are illustrative and not intended to limit embodiments of the present disclosure. For example, although FIG. 2 suggests that topology-based event suppressor 202 will always ignore/drop an event whose event hash value is found in event cache 204, in some embodiments suppressor 202 may allow such an event to be sent to server-side EPS manager 112 on a periodic basis, such as every M times it is matched in event cache 204. With this approach, a commonly occurring event will not be completely blocked from being reported to server-side EPS manager 112 after its first occurrence; the event will simply be reported less frequently, which is consistent with the goal of reducing the total amount of event data transmitted to server system 104.

Further, although topology-based event suppressor 202 is presented in the context of an endpoint protection system, the concepts embodied by suppressor 202 can also be implemented in other types of systems or platforms where limiting the volume of events that are communicated to an event-receiving entity is useful or desirable.

Yet further, the various entities shown in FIGS. 1 and 2 may be organized according to different arrangements/configurations or may include subcomponents or functions that are not specifically described. One of ordinary skill in the art will recognize other variations, modifications, and alternatives.

### 3. Event Suppression Flowchart

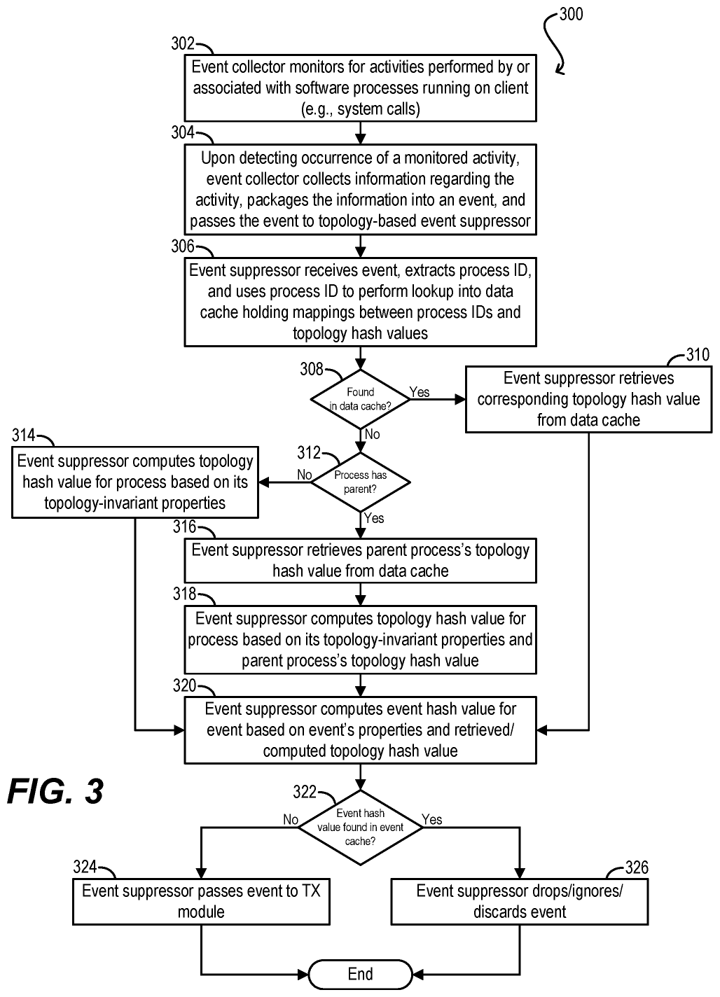

FIG. 3 depicts a flowchart 300 that provides additional details regarding the processing that may be performed by topology-based event suppressor 202 of FIG. 2 for suppressing events according to certain embodiments.

Starting with block 302, event collector 108 can monitor for activities performed by or associated with software processes running on client 102 that can potentially be used to compromise the system. In one set of embodiments, this can include monitoring for the invocation of certain types of OS system calls, such as an “exec” system call that initiates execution of a process, a file write system call for writing to a file, network send and receive system calls for sending and receiving data over a network socket, a script load system call for loading a shell script, a “chmod” system call for changing access permissions on a file or directory, and others.

Upon detecting the occurrence of a monitored activity, event collector 108 can collect information regarding that activity, package the collected information into an event object, and pass the event to topology-based event suppressor 202 (block 304). This information can include the process ID (also known as pid) of the process associated with the event and other activity-specific data. For example, if the detected activity is the invocation of the exec system call, the information can include the path of the binary executed and the command line parameters used. As another example, if the detected activity is the invocation of a file write system call, the information can include the path, inode (i.e., metadata component), and checksum of the file being written. As yet another example, if the detected activity is the invocation of a network send or receive system call, the information can include the source and destination IP addresses and the source and destination ports of the sent/received data.

At block 306, topology-based event suppressor 202 can receive the event from event collector 108, extract the process ID of the event's associated process, and use the process ID to perform a lookup into a data cache that maps process IDs to topology hash values. If the process ID is found in the data cache, topology-based event suppressor 202 can retrieve the corresponding topology hash value from the data cache (blocks 308 and 310).

On the other hand, if the process ID is not found in the data cache at block 308, topology-based event suppressor 202 can further check whether the process has a parent process (block 312). Topology-based event suppressor 202 can perform this step by, e.g., calling an OS-level command such as the “ps” command in Linux. If the answer at block 312 is no, topology-based event suppressor 202 can compute a new topology hash value for the process based on certain non-unique (i.e., topology invariant) properties of the process and store the computed topology hash value, along with the process ID, in the data cache (block 314). For example, the following is an example formula for computing the topology hash value at block 314 for a process P:
topology_hash(P)=hash(P.path, P.cmdline, P.user, P.binary_checksum)

### Listing 1

In this formula, “hash” refers to any hash function, “P.path” refers to the path of the binary for process P, “P.cmdline” refers to the command line used to execute P, and “P.user” refers to the user ID associated with P, and “P.binary_checksum” refers to the checksum (e.g., MD5, etc.) of the process binary.

However, if the answer at block 312 is yes (i.e., the process has a parent), topology-based event suppressor 202 can retrieve the topology hash value for the parent process from the data cache (block 316). Note that this assumes the parent process's topology hash value was previously computed and placed into the data cache as part of processing a prior event pertaining to that parent process. Topology-based event suppressor 202 can then compute a new topology hash value that considers its parent's topology hash value and store the computed topology hash value, along with the process ID, in the data cache (block 318). For example, the following is an example formula for computing the topology hash value at block 318 for a process P with a parent process P.parent:
topology_hash(P)=hash(P.path, P.cmdline, P.user, P.binary_checksum, topology_hash(P.parent))

### Listing 2

Upon completing block 310, 314, or 318, topology-based event suppressor 202 can compute an event hash value for the event based on the event's properties and the topology hash value of the process (block 320). For example, the following is an example formula for computing the event hash value for an event E and associated process P in the case where E corresponds to an exec system call:
event_hash(E)=hash(topology_hash(P), enum_event_type_exec)

### Listing 3

The following is an example formula for computing the event hash value for an event E and associated process P in the case where E corresponds to a file write system call:
event_hash(E)=hash(topology_hash(P), enum_event_type_file, file_path, file_inode, file_checksum)

### Listing 4

The following is an example formula for computing the event hash value for an event E and associated process P in the case where E corresponds to a network send or receive system call:
event_hash(E)=hash(topology_hash(P), enum_event_type_network, local_IP, remote_IP, local_port, remote_port)

### Listing 5

And the following is an example formula for computing the event hash value for an event E and associated process P in the case where E corresponds to a script load system call:
event_hash(E)=hash(topology_hash(P), enum_event_type_script, script_path, script_inode, script_checksum)

### Listing 6

In all of the above formulas, the parameters beginning with “enum” are constant values (i.e., enumerations) indicating the event type to which they are assigned.

Topology-based event suppressor 202 can thereafter check whether the computed event hash value is found in event cache 204 (i.e., is topologically identical to a previously transmitted event) (block 322). If the answer is no, topology-based event suppressor 202 can conclude that the event is likely of interest, pass the event to event TX module 110 for transmission to server system 104, and insert the event hash value into event cache 204 (block 324).

Finally, if the answer at block 322 is yes, topology-based event suppressor 202 can conclude that the event is likely not of interest and ignore/drop/discard the event, thereby preventing it from reaching server system 104 (block 326).

### 4. Event Cache Eviction Policy

With regard to the policy for evicting event cache values from event cache 204, a number of different approaches are possible. For instance, in one set of embodiments topology-based event suppressor 202 can automatically evict event hash values after they have reached a certain age (e.g., X hours or Y days).

In addition to or in lieu of age-based eviction, topology-based event suppressor 202 can evict entries using an LRU (least recently used) or other similar scheme once the event cache's size has reached its maximum allocated capacity. In the case of LRU, topology-based event suppressor 202 can update event cache 204 each time a given event hash value is matched/accessed in the cache in order to reflect that it has been recently “used.” One of ordinary skill in the art will recognize other variations, modifications, and alternatives.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, an event pertaining to an activity performed by or associated with a software process;
computing, by the computer system, an event hash value representing a type of the activity, a type of the software process, and a topology of the software process, the topology indicating one or more parent software processes of the software process;
performing, by the computer system, a lookup into an event cache using the event hash value, the event cache being keyed by event hash values;
upon determining that the event hash value is not found in the event cache, causing the event to be transmitted to an event-receiving entity; and
upon determining that the event hash value is found in the event cache, preventing the event from being transmitted to the event-receiving entity.

2. The method of claim 1 wherein the activity is an invocation of a system call by the software process.

3. The method of claim 2 wherein the system call is a process execution system call, a file write system call, or a network send or receive system call.

4. The method of claim 1 wherein the event includes a process identifier of the software process.

5. The method of claim 4 wherein computing the event hash value comprises:
performing a lookup into a data cache using the process identifier, the data cache including mappings between process identifiers and topology hash values; and
upon determining that the process identifier is found in the data cache:
retrieving a topology hash value mapped to the process identifier in the data cache; and
computing the event hash value based on one or more properties of the event and the topology hash value.

6. The method of claim 4 wherein computing the event hash value comprises:
performing a lookup into a data cache using the process identifier, the data cache including mappings between process identifiers and topology hash values; and
upon determining that the process identifier is not found in the data cache:
determining that the software process has a parent software process;
retrieving a parent topology hash value for the parent software process from the data cache;
computing a topology hash value for the software process based on one or more properties of the software process and the parent topology hash value; and
computing the event hash value based on one or more properties of the event and the topology hash value.

7. The method of claim 4 wherein computing the event hash value comprises:
performing a lookup into a data cache using the process identifier, the data cache including mappings between process identifiers and topology hash values; and
upon determining that the process identifier is not found in the data cache:
determining that the software process does not have a parent software process;
computing a topology hash value for the software process based on one or more properties of the software process; and
computing the event hash value based on one or more properties of the event and the topology hash value.

8. A non-transitory computer readable storage medium having stored thereon program code executable by a computer system, the program code embodying a method comprising:
receiving an event pertaining to an activity performed by or associated with a software process;
computing an event hash value representing a type of the activity, a type of the software process, and a topology of the software process, the topology indicating one or more parent software processes of the software process;
performing a lookup into an event cache using the event hash value, the event cache being keyed by event hash values;
upon determining that the event hash value is not found in the event cache, causing the event to be transmitted to an event-receiving entity; and
upon determining that the event hash value is found in the event cache, preventing the event from being transmitted to the event-receiving entity.

9. The non-transitory computer readable storage medium of claim 8 wherein the activity is an invocation of a system call by the software process.

10. The non-transitory computer readable storage medium of claim 9 wherein the system call is a process execution system call, a file write system call, or a network send or receive system call.

11. The non-transitory computer readable storage medium of claim 8 wherein the event includes a process identifier of the software process.

12. The non-transitory computer readable storage medium of claim 11 wherein computing the event hash value comprises:
performing a lookup into a data cache using the process identifier, the data cache including mappings between process identifiers and topology hash values; and
upon determining that the process identifier is found in the data cache:
retrieving a topology hash value mapped to the process identifier in the data cache; and
computing the event hash value based on one or more properties of the event and the topology hash value.

13. The non-transitory computer readable storage medium of claim 11 wherein computing the event hash value comprises:
performing a lookup into a data cache using the process identifier, the data cache including mappings between process identifiers and topology hash values; and
upon determining that the process identifier is not found in the data cache:
determining that the software process has a parent software process;
retrieving a parent topology hash value for the parent software process from the data cache;
computing a topology hash value for the software process based on one or more properties of the software process and the parent topology hash value; and
computing the event hash value based on one or more properties of the event and the topology hash value.

14. The non-transitory computer readable storage medium of claim 11 wherein computing the event hash value comprises:
performing a lookup into a data cache using the process identifier, the data cache including mappings between process identifiers and topology hash values; and
upon determining that the process identifier is not found in the data cache:
determining that the software process does not have a parent software process;
computing a topology hash value for the software process based on one or more properties of the software process; and
computing the event hash value based on one or more properties of the event and the topology hash value.

15. A computer system comprising:
a processor; and
a non-transitory computer readable medium having stored thereon program code that, when executed, causes the processor to:
receive an event pertaining to an activity performed by or associated with a software process;
compute an event hash value representing a type of the activity, a type of the software process, and a topology of the software process, the topology indicating one or more parent software processes of the software process;
perform a lookup into an event cache using the event hash value, the event cache being keyed by event hash values;
upon determining that the event hash value is not found in the event cache, cause the event to be transmitted to an event-receiving entity; and
upon determining that the event hash value is found in the event cache, prevent the event from being transmitted to the event-receiving entity.

16. The computer system of claim 15 wherein the activity is an invocation of a system call by the software process.

17. The computer system of claim 16 wherein the system call is a process execution system call, a file write system call, or a network send or receive system call.

18. The computer system of claim 15 wherein the event includes a process identifier of the software process.

19. The computer system of claim 18 wherein the program code that causes the processor to compute the event hash value comprises program code that causes the processor to:
perform a lookup into a data cache using the process identifier, the data cache including mappings between process identifiers and topology hash values; and
upon determining that the process identifier is found in the data cache:
retrieve a topology hash value mapped to the process identifier in the data cache; and
compute the event hash value based on one or more properties of the event and the topology hash value.

20. The computer system of claim 18 wherein the program code that causes the processor to compute the event hash value comprises program code that causes the processor to:
perform a lookup into a data cache using the process identifier, the data cache including mappings between process identifiers and topology hash values; and
upon determining that the process identifier is not found in the data cache:
determine that the software process has a parent software process;
retrieve a parent topology hash value for the parent software process from the data cache;
compute a topology hash value for the software process based on one or more properties of the software process and the parent topology hash value; and
compute the event hash value based on one or more properties of the event and the topology hash value.

21. The computer system of claim 18 wherein the program code that causes the processor to compute the event hash value comprises program code that causes the processor to:
perform a lookup into a data cache using the process identifier, the data cache including mappings between process identifiers and topology hash values; and
upon determining that the process identifier is not found in the data cache:
determine that the software process does not have a parent software process;
compute a topology hash value for the software process based on one or more properties of the software process; and
compute the event hash value based on one or more properties of the event and the topology hash value.
